(19) United States
(12) Patent Application Publication
(10) Pub. No.: US 2015/0022696 A1
(43) Pub. Date: Jan. 22, 2015

(54) ELECTRONIC DEVICE HAVING CAMERA MODULE AND OPERATING METHOD THEREOF

(71) Applicant: Samsung Electronics Co., Ltd., Gyeonggi-do (KR)

(72) Inventor: Joon-Sung Park, Gyeonggi-do (KR)

(21) Appl. No.: 14/333,372

(22) Filed: Jul. 16, 2014

(30) Foreign Application Priority Data
Jul. 16, 2013 (KR) 10-2013-0083354

(51) Int. Cl. G02B 7/09; H04N 5/232

(52) U.S. Cl. CPC G02B 7/09; H04N 5/23296
USPC 348/240.3; 359/694

(57) ABSTRACT

An electronic device including a camera module that operates intuitively and an operating method thereof are provided. In a method for operating an electronic device, a rotation event of a zoom ring is detected for a predetermined time. A zoom speed of a barrel is determined in response to the detected rotation event. A zoom-in function or a zoom-out function is performed with the determined zoom speed.

### PRIORITY

The present application is related to and claims the benefit under 35 U.S.C. §119(a) of a Korean patent application filed in the Korean Intellectual Property Office on Jul. 16, 2013 and assigned Serial No. 10-2013-0083354, the entire disclosure of which is hereby incorporated by reference.

### TECHNICAL FIELD

The present disclosure relates to an electronic device. More particularly, the present disclosure relates to an electronic device having a camera module and an operating method thereof.

### BACKGROUND

Recently, as the electronic industry and communication technology develops, a new service based on data, voice, and video is being quickly developed. A rapid development of micro electronic technology as well as computer software and hardware technologies have become a foundation for electronic devices with increasing processing complexity. Electronic devices can also provide a range that resolves network limitations so that stronger functionality can be achieved. Also, user demand for electronic devices and particularly mobile terminals such as smart phones are urgent. As such users prefer electronic devices which can have greater functionality and more flexibility.

With development of communication technology, electronic devices can evolve into a multimedia device providing not only a voice communication service but also various multimedia services using a data communication service. Particularly, electronic devices can have a camera module as a basic specification, so that it is difficult to find an electronic device without a camera module. Because electronic devices are easy to carry, a user can capture necessary moments almost instantly and can obtain a personal photos with various custom shooting effects.

### SUMMARY

To address the above-discussed deficiencies, it is a primary object to provide an electronic device having a camera module and an operating method thereof.

Another aspect of the present disclosure is to provide an electronic device having a camera module having reliability and durability and an operating method thereof.

Still another aspect of the present disclosure is to provide an electronic device having a camera module that operates intuitively and an operating method thereof.

In accordance with an aspect of the present disclosure, a method for operating an electronic device is provided. The method includes detecting a rotation event of a zoom ring for a predetermined time, determining a zoom speed of a barrel in response to the detected rotation event, and performing a zoom-in function or a zoom-out function with the determined zoom speed.

In accordance with an aspect of the present disclosure, detecting the rotation event of the zoom ring for the predetermined time can include measuring the number of rotation events of the zoom ring for the predetermined time.

In accordance with an aspect of the present disclosure, the number of rotation events can be the number of times by which a plurality of objects to be sensed and installed on the zoom ring are sensed by a sensing means of the electronic device.

In accordance with an aspect of the present disclosure, the object to be sensed can be a magnet, and a magnetic force of the magnet can be sensed by a Hall sensor or a rotation sensor.

In accordance with an aspect of the present disclosure, when the object to be sensed is not sensed, an operation of the barrel can be stopped.

In accordance with an aspect of the present disclosure, when the measured number of rotation events is equal to or greater than a reference value, the zoom speed can increase, and when the measured number of rotation events is less than the reference value, the zoom speed can decrease.

In accordance with an aspect of the present disclosure, the method can further include comparing the number of rotation events with a value of a pivot table stored in a memory of the electronic device to determine the zoom speed.

In accordance with an aspect of the present disclosure, the method can further include, when measuring the number of rotation events for the predetermined time, detecting at least one of a rotation speed, a rotation acceleration, or a rotation direction of the zoom ring.

In accordance with an aspect of the present disclosure, the method can further include performing a zoom-in function or a zoon-out function of the barrel depending on a rotation direction of the zoom ring.

In accordance with an aspect of the present disclosure, the method can further include determining the zoom speed depending on the rotation speed of the zoom ring.

In accordance with another aspect of the present disclosure, an electronic device can be provided. The electronic device can include a camera module including a zoom ring and a barrel, and a processor coupled to the camera module. The processor can be configured to sense a rotation event of the zoom ring for a predetermined time, to determine a zoom speed of a barrel in response to the sensed rotation event, or to perform a zoom-in function or a zoom-out function with the determined zoom speed.

In accordance with another aspect of the present disclosure, the processor can be configured to measure the number of rotation events of the zoom ring for a predetermined time.

In accordance with another aspect of the present disclosure, the electronic device can further include a sensing unit configured to sense a plurality of objects installed on the zoom ring in order to measure the number of rotation events.

In accordance with another aspect of the present disclosure, the object to be sensed can be a magnet, and a magnetic force of the magnet can be sensed by a Hall sensor or a rotation sensor.

In accordance with another aspect of the present disclosure, when the object to be sensed is not sensed, the processor can be configured to stop an operation of the barrel.

In accordance with another aspect of the present disclosure, when the measured number of rotation events is equal to or greater than a reference value, the processor can be configured to increase the zoom speed, and when the measured number of rotation events is less than the reference value, the processor can he configured to reduce the zoom speed.

In accordance with another aspect of the present disclosure, the processor can be configured to compare the number of rotation events with a pivot table value stored in a memory of the electronic device and to determine the zoom speed.

In accordance with another aspect of the present disclosure, when measuring the number of rotation events for a predetermined time, the processor can be configured to detect at least one of a rotation speed, a rotation acceleration, or a rotation direction of the zoom ring.

In accordance with another aspect of the present disclosure, the processor can be configured to control a zoom-in function or a zoon-out function of the barrel depending on a rotation direction of the zoom ring.

In accordance with another aspect of the present disclosure, the processor can be configured to determine the zoom speed depending on the rotation speed of the zoom ring.

According to the various embodiments, an electronic device can have a camera module with reliability and durability, and operating intuitively, and an operating method thereof can be provided.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a front perspective view illustrating an example electronic device including a camera module according to this disclosure;

FIG. 2 is a rear perspective view illustrating an example electronic device including a camera module according to this disclosure;

FIG. 3 is a separated perspective view illustrating an example rotation driver of a camera module according to this disclosure;

FIG. 4 is a coupled perspective view illustrating an example rotation driver of a camera module according to this disclosure;

FIG. 5 is a block diagram illustrating an example electronic device according to this disclosure;

FIG. 6 is a flowchart illustrating an example method for operating an electronic device according to this disclosure;

FIG. 7 is a flowchart illustrating an example method for operating an electronic device according to this disclosure;

FIG. 8 is a flowchart illustrating an example method for operating an electronic device according to this disclosure; and

FIG. 9 is a flowchart illustrating an example method for operating an electronic device according to this disclosure.

Throughout the drawings, like reference numerals will be understood to refer to like parts, components and structures.

### DETAILED DESCRIPTION

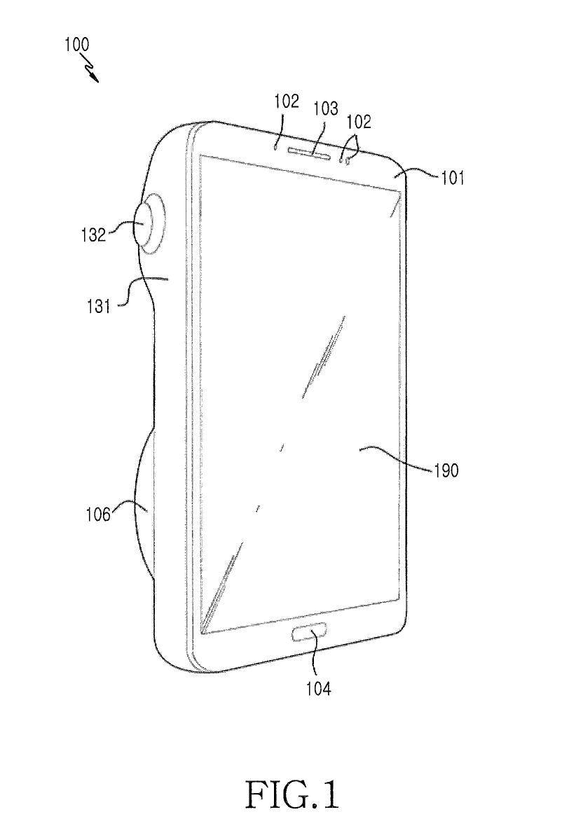

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

In describing various embodiments of the present disclosure, an electronic device including one or more camera modules is described. The electronic device can include a display unit for displaying image information shot by a camera module.

In describing various embodiments of the present disclosure, an electronic device including a touchscreen as a display unit and one or more camera modules is illustrated and described, but it is not limited thereto. For example, the present disclosure is applicable to various electronic devices including one or more camera modules, that is, a Personal Digital Assistant (PDA), a laptop computer, a mobile phone, a smart phone, a netbook, a Mobile Internet Device (MID), an Ultra Mobile Personal Computer (UMPC), a tablet PC, a navigation, an MP3 player, a general camera device, etc.

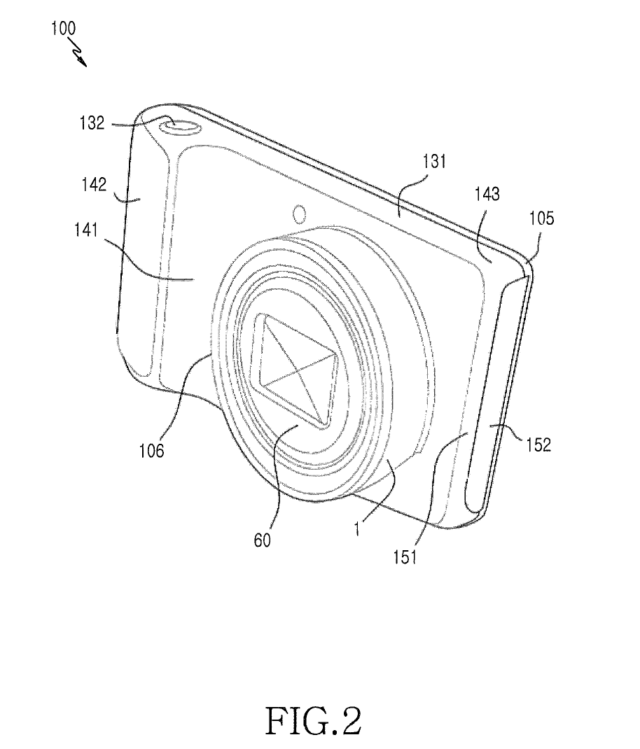

FIG. 1 is a front perspective view illustrating an example electronic device including a camera module according to this disclosure, and FIG. 2 is a rear perspective view illustrating an example electronic device including a camera module according to this disclosure.

Referring to FIGS. 1 and 2, the electronic device 100 can include a touchscreen 190 installed on its front side 101. The touchscreen 190 can perform data input/output, apply a touch detect technology, and display visual information, text, graphics, video, or the like. A speaker module 103 can be installed on the upper portion of the touchscreen 190, and a physical button 104 (such as a ‘home’ button) can be disposed on the lower portion of the touchscreen 190. A plurality of sensors 102 for providing use convenience of the electronic device 100 can be included on one side of the speaker module 103. These sensors 102 can be a proximity sensor or an illuminance sensor depending on various embodiments. However, they are not limited thereto, but various sensors can be omitted and disposed.

A camera module 106 and a grip portion 142 can be included on the rear side of the electronic device 100. The camera module 106 can include a camera barrel 60 for receiving a plurality of lenses, an aperture, a shutter, or the like. The camera module can also include a rotation driver 1 surrounding the camera barrel 60. According to various embodiments, as a rotor (such as a zoom ring) of the rotation driver 1 rotates, the camera module 106 can be configured to perform a zoom-in or zoom-out operation. The grip portion 142 can include a shape disposed near the edge of the electronic device 100 and protruding to the front side so that a user can easily grip the electronic device 100 using the grip portion 142. A material (such as rubber, leather, or the like) for improving a user' sense of grip can be applied to the grip portion 142.

A shooting button 132 positioned adjacent to the grip portion 142 of the rear side 141 can be disposed on the upper side 131 of the electronic device 100. A detachable cover 152 can be disposed on the lateral side 151 of the electronic device 100. The electronic device 100 can have a front housing 105 disposed on the front side 101 and a rear housing 143 disposed on the rear side 141.

The camera module 106 can protrude to a predetermined height from the outer surface of the rear housing 143. The camera module 106 can be disposed on the front side 101 of the electronic device 100 to perform a self camera function, or can be used for video communication. The camera module 106 can shoot a still image or a moving picture, and output shot image information via the touchscreen 190.

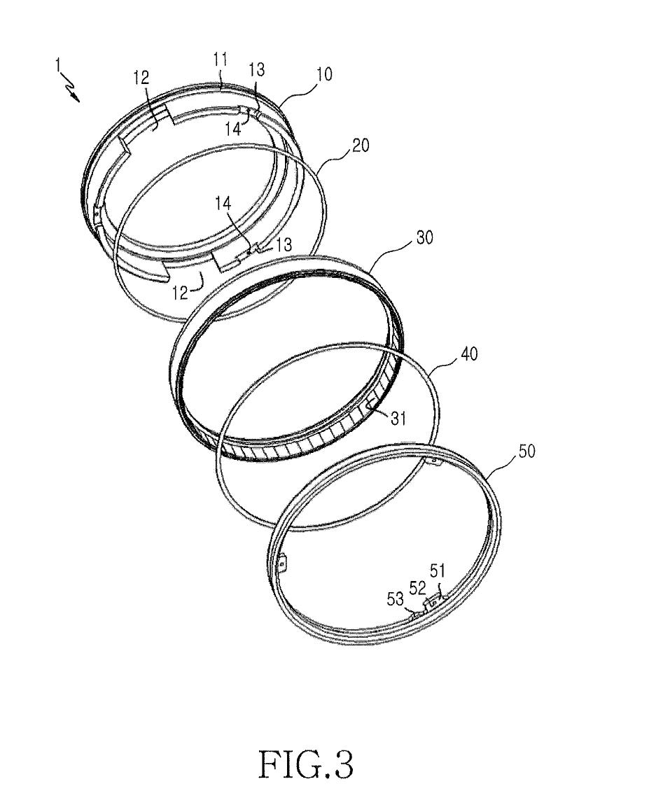

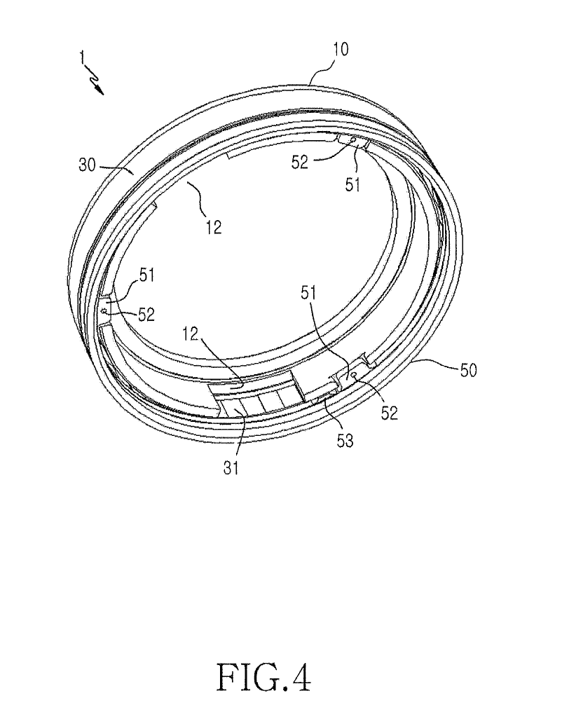

FIG. 3 is a separated perspective view illustrating an example rotation driver of a camera module according to this disclosure, and FIG. 4 is a coupled perspective view illustrating an example rotation driver of a camera module according to this disclosure.

Referring to FIGS. 3 and 4, a rotation driver 1 can include a first cavity member 10, a rubber ring 20, a rotor 30, a lubrication tape 40 (such as a Teflon type), and a second cavity member 50.

The first cavity member 10 can be a circular shape having a predetermined height generally. The first cavity member 10 can have at least one opening 12 opening an inner portion and an outer portion. The opening 12 can be opened in the direction of the second cavity member 50. A circular object 31 of the rotor 30 which is to be sensed can be exposed via the opening 12. A groove 11 to which the rubber ring 20 can be fit can be formed in the outer surface of the first cavity member 10. A plurality of coupling recesses can be formed in a circular lower surface of the first cavity member 10. A bolt fasten recess 14 can be formed in the inner side of the plurality of coupling recesses. The plurality of coupling recesses 13 can communicate with a plurality of bolt fasten recesses 52 of the second cavity member 50.

The rubber ring 20 can be disposed in the groove 11 of the first cavity member 10. The rubber ring 20 can have flexibility and elasticity. The rotor 30 can be disposed in the outer side of the first cavity member 10, and can be rotatable in the outer periphery of the first cavity member 10. The rotor 30 can have a cylindrical shape with a predetermined height. The circular object 31 to be sensed by a rotation sensor can be disposed on a cavity surface of the rotor 30. The circular object 31 to be sensed can be a magnet. A Hall sensor or a rotation sensor can sense magnetic force of the magnet. The lubrication tape 40 (such as a Teflon tape) can be attached to the second cavity member 50. The lubrication tape 40 can be a circular ring shape. The first cavity member 10 and the second cavity member 50 can be coupled to each other. The rotor 30 can rotate between the first cavity member 10 and the second cavity member 50.

The second cavity member 50 can be a cylindrical shape having a predetermined height. The second cavity member 50 can have a plurality of coupling pieces 51 extending to the central direction from the cavity surface. The plurality of coupling pieces 51 can have the bolt fasten hole (recess) 52. The second cavity member 50 can have a plurality of support pieces 53 extending to the central direction from the cavity surface. The plurality of coupling pieces 51 can be inserted into the plurality of coupling recesses 13 of the first cavity member 10. The plurality of support pieces 53 can contact the cavity surface of the first cavity member 10. The plurality of support pieces 53 can prevent eccentricity of the first cavity member 10.

According to various embodiments, the camera module 106 can include a camera barrel 60 for receiving a plurality of lenses, an aperture, a shutter, or the like. The camera module 106 can also include a rotation driver 1 surrounding the camera barrel 60 and a barrel holder for fixing the camera barrel 60 with the rotation driver 1. However, the camera module 106 is not limited thereto but can further include various elements. The camera module 106 can be configured perform a camera function of the electronic device 100, and a rotation sensor can be installed on the outer surface of the barrel holder of the camera module 106. The rotation sensor can react to rotation of the rotor 30 and sense the circular object 31 to be sensed, exposed via the opening 12 of the first cavity member 10. For example, instead of the rotation sensor, a Hall sensor can be installed. The rotation sensor can be electrically connected to the Printed Circuit Board (PCB) of the electronic device 100.

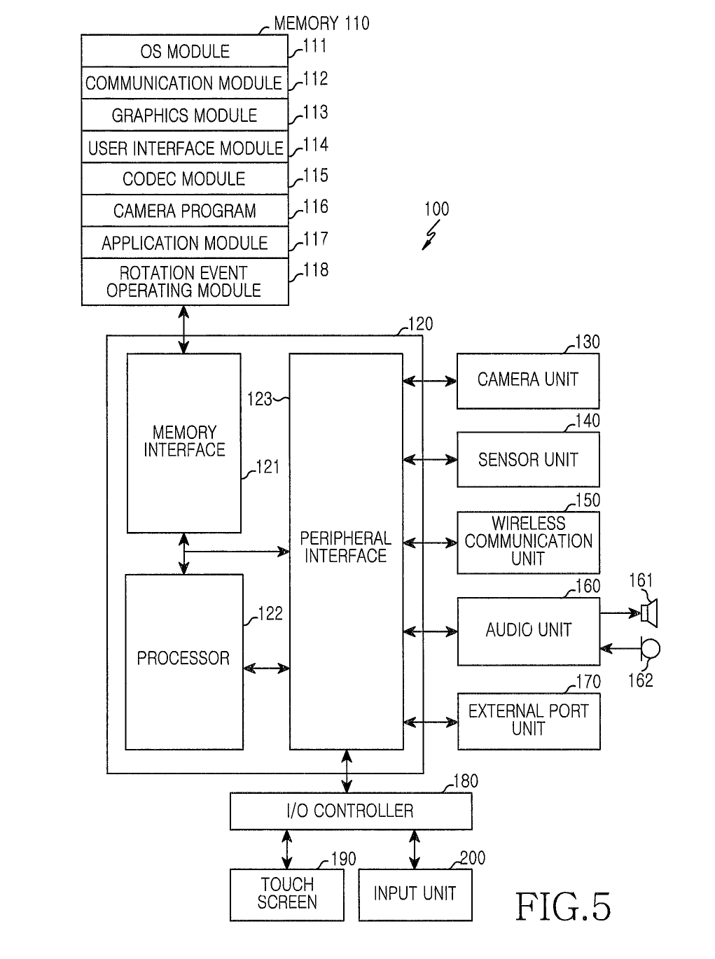

FIG. 5 is a block diagram illustrating an example electronic device according to this disclosure.

Referring to FIG. 5, the electronic device 100 can be a device such as a mobile phone, a media player, a tablet computer, a handheld computer, a PDA and a general camera. Also, the electronic device 100 can be an arbitrary portable terminal including a device combining two or more functions among these devices.

The electronic device 100 can include a memory 110, a processor unit 120, a camera unit 130, a sensor unit 140, a wireless communication unit 150, an audio unit 160, an external port unit 170, an Input/Output (I/O) controller 180, a touchscreen 190, and an input unit 200. Also, a plurality of memories 110 and external port units 170 can be provided.

Each element is described below.

The processor unit 120 can include a memory interface 121, at least one processor 122, and a peripheral interface 123. Here, the memory interface 121, the at least one processor 122, and the peripheral interface 123 included in the processor unit 120 can be integrated in at least one integrated circuit or implemented as separate elements.

The memory interface 121 can be configured to control memory access of elements such as the processor 122 and the peripheral interface 123.

The peripheral interface 123 can be configured to control a connection between Input/Output (I/O) peripheral units of the electronic device 100 as well as the processor 122 and the memory interface 121.

The processor 122 can be configured to control the electronic device 100 in order to provide various multimedia services using at least one software program. At this point, the processor 122 can be configured to execute at least one program stored in the memory 110 in order to provide a service corresponding to a relevant program. The processor 122 can perform various functions for the electronic device as well as perform processes and controls for voice communication, video communication, and data communication.

The processor 122 can be configured to perform one or more methods according to various embodiments of this disclosure in cooperation with software modules stored in the memory 110. According to various embodiments, the processor 122 can be configured to determine a zoom speed of the barrel in response to a rotation event of the zoom ring. Also, the processor 122 can be configured to control to perform a zoom-in or zoom-out function with the determined zoom speed.

The processor 122 can include one or more data processors, image processors, or CODECs. Furthermore, the electronic device 100 can include a data processor, an image processor, or a CODEC, separately.

The camera unit 130 can be configured to perform a camera function such as a photo, video clip recording, or the like. The camera unit 130 can include a Charged Coupled Device (CCD) or a Complementary Metal Oxide Semiconductor (CMOS), etc. The camera unit 130 via the processor 122 can be configured to control a hardware configuration change, such as a lens movement, a zoom-in or zoom-out operation, a number of an aperture, or the like.

Various elements of the electronic device 100 can be connected via one or more communication buses or an electric connection.

The sensor unit 140 can include a motion sensor, a proximity sensor, an illuminance sensor, an image sensor, a Hall sensor, a rotation sensor, or the like. The motion sensor can be configured to sense movement of the electronic device 100, and the illuminance sensor can be configured to sense ambient light. The rotation sensor can be configured to sense the circular object 31 to be sensed, exposed via the opening 12 of the first cavity member 10 in response to rotation of the rotor 30. The circular object 31 to be sensed can be sensed by a Hall sensor. The sensor unit 140 can include various sensors besides the above-described sensor.

The wireless communication unit 150 can be configured to enable wireless communication and can include a Radio Frequency (RF) transmitter/receiver or a light (such as an infrared) transmitter/receiver. The wireless communication unit 150 can be configured to operate via at least one of a GSM network, an EDGE network, a CDMA network, a W-CDMA network, an LTE network, an OFDMA network, a Wi-Fi network, a WiMax network, and a Bluetooth network depending on a communication network.

The audio unit 160 can be connected to a speaker 161 and a microphone 162 to take charge of voice duplication, digital recording, or audio input and output such as a phone function. The audio unit 160 can be configured to provide an audio interface between a user and the electronic device 100, to receive a data signal from the processor unit 120, to convert the received data signal to an electric signal, and to output the converted electric signal via the speaker 161.

The speaker 161 can be configured to convert an electric signal to an audible frequency signal, and output the same, and can be disposed in the front or the rear of the electronic device 100. The speaker 161 can include a flexible film speaker where at least one piezoelectric body has been attached to one vibration film.

The microphone 162 can be configured to convert a sound wave transferred from a person or other sound sources to an electric signal. Also, the audio unit 160 can be configured to receive an electric signal from the microphone 162, to convert the received electric signal to an audio data signal, and to transmit the converted audio data signal to the processor unit 120. The audio unit 160 can include an earphone, an ear set, a headphone, or a head set detachable from the electronic device 100.

The external port unit 170 can be configured to directly connect the electronic device 100 to a counterpart electronic device, or to indirectly connect the electronic device 100 to a counterpart electronic device via a network (such as the Internet, an Intranet, a wireless LAN, or the like.)

The I/O controller 180 can be configured to provide an interface between an I/O unit such as the touchscreen 190 and the input unit 200, and the peripheral interface 123.

The touchscreen 190 can be configured to provide an I/O interface between the electronic device 100 and a user. For example, the touchscreen 190 can be configured to apply a touch detect technology, to transfer a user's touch input to the processor unit 120, and to show visual information, text, graphics, or video, or the like provided from the processor unit 120 to the user. The touchscreen 190 can be configured to display state information of the electronic device 100, a character input by the user, a moving picture, a still picture, or the like. The touchscreen 190 can display application information driven by the processor 122.

The touchscreen 190 can further apply an arbitrary multi-touch detect technology including not only capacitive, resistive, infrared, and surface acoustic wave technologies but also other proximity sensor arrangements or other elements. The touchscreen 190 can apply at least one of a Liquid Crystal Display (LCD), an Organic Light Emitting Diode (OLED), an Active Matrix Organic Light Emitting Diode (AMOLED), a flexible display, and a 3 dimensional display.

The input unit 200 can be configured to provide input data generated by the user's selection to the processor 122 via the I/O controller 180. At this point, the input unit 200 can include a keypad including at least one hardware button, a touch pad for detecting touch information, etc. The input unit 200 can include an up/down button for volume control. Besides, the input unit 200 can include at least one of a push button, a locker button, a locker switch, a thumb-wheel, a dial, a stick, and a pointer device such as a stylus or the like to which a relevant function has been given.

The memory 110 can include a high speed random access memory such as one or more magnetic disk storages or a non-volatile memory, one or more optical storages or a flash memory (such as NADN, NOR). The memory 110 can be configured to store software. The software can include an Operating System (OS) module 111, a communication module 112, a graphics module 113, a user interface module 114, a CODEC module 115, a camera program 116, an application module 117, and a rotation event operating module 118. A terminology of a module can be expressed as a set of instructions, an instruction set, or a program.

The OS module 111 can include WINDOWS, LINUX, Darwin, RTXC, UNIX, OS X, or a built-in OS such as VxWorks, and can include various software elements for controlling general system operations. The control of the general system operation can include memory control and management, storage hardware (device) control and management, power control and management, etc. The OS module 111 can also be configured to perform a function for swift communication between various hardwares (devices) and softrwares (modules).

The communication module 112 can be configured to enable communication with a counterpart electronic device such as a computer, a server, an electronic device, or the like via the wireless communication unit 150 or the external port unit 170.

The graphics module 113 can include various software elements for providing and displaying graphics on the touchscreen 190. A terminology of graphics can mean text, a web page, an icon, a digital image, a video, an animation, and the like.

The user interface module 114 can include various software elements related to a user interface. The user interface module 114 can be configured to control display information of an application driven by the processor 122 on the touchscreen 190. The user interface module 114 can include content regarding how a state of the user interface changes or under what condition the state of the user interface changes.

The CODEC module 115 can include a software element related to encoding and decoding of a video file.

The camera program 116 can include a camera-related software element enabling camera-related processes and functions.

The application module 117 can include a software element for at least one application installed in the electronic device 100. The application can include a browser, an e-mail, a phonebook, games, a short message service, a multimedia message service, an SNS, an instant message, a morning call, an MP3 player, a schedule management, a camera, word processing, keyboard emulation, an address book, a contact list, a widget, Digital Right Management (DRM), voice recognition, voice duplication, a position determining function, or a position based service, etc.

The rotation event operating module 118 can include at least one software element for managing a zoom-in or zoom-out operation depending on a sensed rotation event in response to rotation of the zoom ring. The rotation event operating module 118 can be configured to determine the number of rotation events, the rotation speed, the rotation direction, the rotation acceleration, or the like of the zoom ring included in the rotation event, and to include various routines for a related process and rotation event operation support so that the camera module 106 can operate depending on the rotation event. Also, the rotation event operating module 118 can include a pivot table having zoom speed information corresponding to a rotation event.

The processor unit 120 can further include an additional module (instructions) besides the above-described module. Also, various functions of the electronic device 100 according to various embodiments of the present disclosure can include a hardware or a software including one or more processings or an Application Specific Integrated Circuit (ASIC).

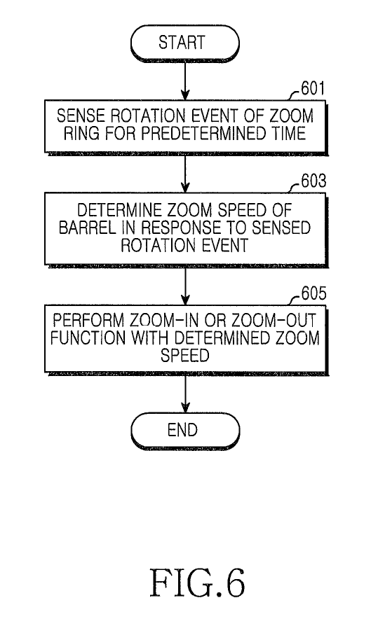

FIG. 6 is a flowchart illustrating a method for operating an electronic device according to an embodiment of the present disclosure.

Referring to FIG. 6, the electronic device 100 can be configured to sense a rotation event of the zoom ring for a predetermined time in step 601. According to various embodiments, the electronic device 100 can be configured to measure the number of rotation events while the zoom ring rotates. For example, the zoom ring can include a plurality of objects to be sensed by a rotation sensor or a Hall sensor of the electronic device 100. The electronic device 100 can be configured to determine the rotation speed, the rotation acceleration, the rotation direction, or the like of the zoom ring via the number of rotation events sensed for a predetermined time.

Next, the electronic device 100 can be configured to determine a zoom speed of a barrel in response to a rotation event detected in step 603. According to various embodiments, the electronic device 100 can be configured to determine a zoom speed of the barrel depending on the number of rotation events detected for a predetermined time.

According to an embodiment, the zoom speed depending on the number of rotation events can be represented by Table 1 below.

TABLE 1

| the number of events detected | | zoom speed of |
|---|---|---|
| within a first unit time | zoom speed mode | the barrel |
| 0 | stop | 0 |
| 1~4 | slow | 10 |
| 4~7 | normal | 15 |
| 8~10 | fast | 20 |
| 11~ | very fast | 25 |

Referring to Table 1, in the case where the number of events detected within a first unit time is 7 according to various embodiments, the electronic device 100 can be configured to apply a zoom speed mode to a normal mode, and to control the zoom speed of the barrel to 15 mm/s. Also, in the case where the number of events detected within a second unit time is 3, the electronic device 100 can be configured to apply a zoom speed mode to a slow mode and reduce the zoom speed of the barrel to 10 mm/s. Also, in the case where the number of events detected within a third unit time is 0, the electronic device 100 can be configured stop the zoom function of the barrel. For example, in case of comparing the number of rotation events detected within the first unit time with the number of rotation events detected within the second unit time, the electronic device 100 can be configured to set an error range separately. The electronic device 100 can be configured to set the zoom speed of the barrel in this manner.

As described above, though the zoom speed depending on the number of events sensed for the predetermined time has been described with reference to Table 1, the zoom speed is not limited thereto. For example, the number of events sensed within a unit time can be set by a user, and a zoom speed mode and a zoom speed of the barrel depending on the zoom speed mode can be set variously.

Next, the electronic device 100 can be configured to perform a zoom-in or zoom-out function at the zoom speed determined in step 605. According to various embodiments, the electronic device 100 can be configured to perform a zoom-in or zoom-out function depending on the rotation direction of the zoom ring. The electronic device 100 can be configured to compare the number of events sensed for a predetermined time to increase or reduce the zoom speed of the barrel or stop the zoom function.

An instruction set for each operation can be stored as one or more modules in the above-described memory 110. In this case, the module stored in the memory 110 can be executed by one or more processors 122.

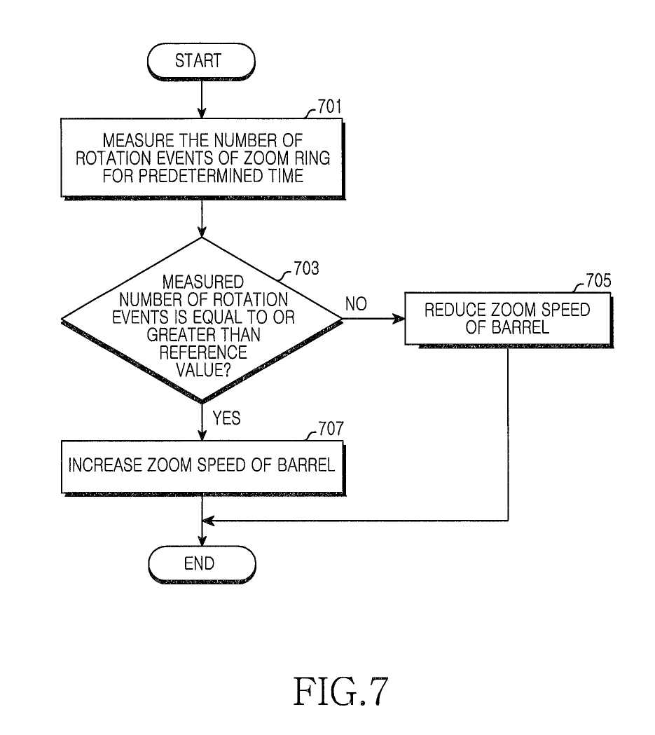

FIG. 7 is a flowchart illustrating an example method for operating an electronic device according to this disclosure.

Referring to FIG. 7, the electronic device 100 can measure the number of rotation events of the zoom ring for a predetermined time in step 701. According to various embodiments, the electronic device 100 can measure the number of rotation events while the zoom ring rotates. For example, the zoom ring can include a plurality of objects sensed by a rotation sensor of the electronic device 100. When sensing the object to be sensed one time, the electronic device 100 can recognize the number of rotation events as 1. The electronic device 100 can determine the rotation speed, the rotation acceleration, the rotation direction, or the like of the zoom ring via the number of rotation events sensed for a predetermined time.

Next, the electronic device 100 can determine whether the measured number of rotation events is equal to or greater than a reference value in step 703. According to various embodiments, the electronic device 100 can refer to a pivot table value stored in the memory 110. For example, the electronic device 100 can compare the number of rotation events measured for a predetermined time with a pivot table value of Table 1.

When the measured number of rotation events is less than the reference value, the electronic device 100 can reduce the zoom speed of the barrel in step 705. According to various embodiments, the electronic device 100 can reduce the zoom speed of the barrel to a zoom speed corresponding to Table 1.

When the measured number of rotation events is equal to or greater than the reference value, the electronic device 100 can increase the zoom speed of the barrel in step 707. According to various embodiments, the electronic device can increase the zoom speed of the barrel to a zoom speed corresponding to Table 1.

An instruction set for each operation can be stored as one or more modules in the above-described memory 110. In this case, the module stored in the memory 110 can be executed by one or more processors 122.

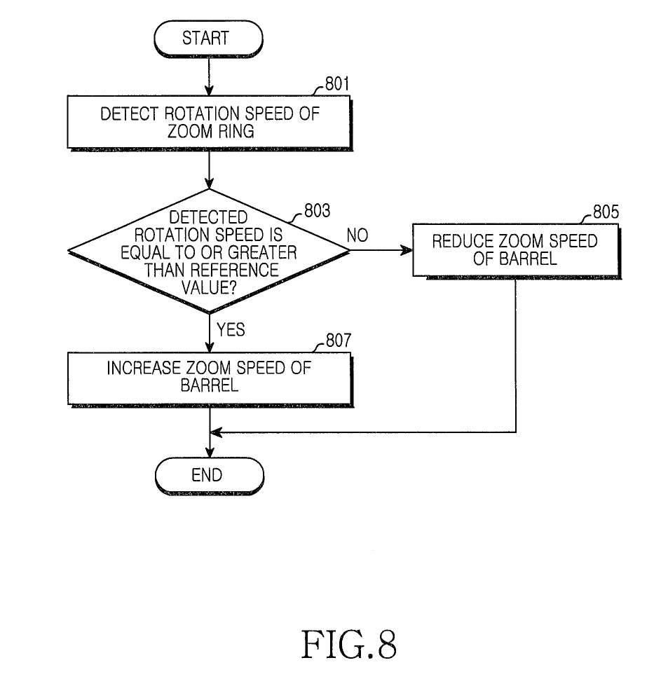

FIG. 8 is a flowchart illustrating a method for operating an electronic device according to this disclosure.

Referring to FIG. 8, the electronic device 100 can detect the rotation speed of the zoom ring in step 801. According to various embodiments, the electronic device 100 can sense an object to be sensed while the zoom ring rotates. For example, the zoom ring can include a plurality of objects sensed by a rotation sensor of the electronic device 100. The electronic device 100 can detect the rotation speed of the zoom ring by sensing the objects to be sensed for a predetermined time.

Next, the electronic device 100 can determine whether the rotation speed detected in step 803 is equal to or greater than a reference value. According to various embodiments, the electronic device 100 can increase or reduce the zoom speed of the barrel or stop a zoom function depending on the detected rotation speed.

When the detected rotation speed is less than the reference value, the electronic device 100 can reduce the zoom speed of the barrel in step 805. According to various embodiments, the electronic device 100 can reduce the zoom speed of the barrel to a zoom speed corresponding to a pivot table with reference to the pivot table stored in the memory 110.

When the detected rotation speed is equal to or greater than the reference value, the electronic device 100 can increase the zoom speed of the barrel in step 807. According to various embodiments, the electronic device 100 can increase the zoom speed of the barrel to a zoom speed corresponding to the pivot table with reference to the pivot table stored in the memory 110.

An instruction set for each operation can be stored as one or more modules in the above-described memory 110. In this case, the module stored in the memory 110 can be executed by one or more processors 122.

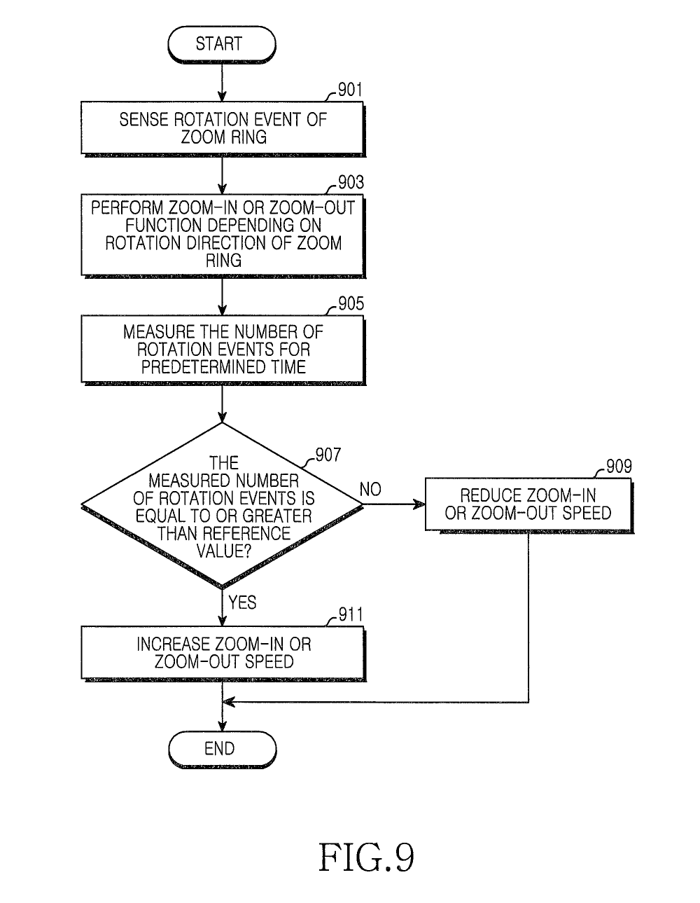

FIG. 9 is a flowchart illustrating an example method for operating an electronic device according to this disclosure.

Referring to FIG. 9, the electronic device 100 can detect a rotation event of the zoom ring in step 901. According to various embodiments of the present disclosure, the electronic device 100 can sense an object to be sensed, installed with the zoom ring while the zoom ring rotates. The object to be sensed can be the plural, and can be sensed by a rotation sensor or a Hall sensor of the electronic device 100. Also, the electronic device 100 can determine the rotation direction of the zoom ring by sensing the plurality of objects to be sensed while the zoom ring rotates.

Next, the electronic device 100 can perform a zoom-in or zoom-out function depending on the rotation direction of the zoom ring in step 903. According to various embodiments, the electronic device 100 can operate the zoom-in function when the rotation direction of the zoom ring is a clockwise direction, and can operate the zoom-out function when the rotation direction of the zoom ring is a counterclockwise direction.

Next, the electronic device 100 can measure the number of rotation events for a predetermined time in step 905. According to various embodiments, when sensing the object to be sensed of the zoom ring one time, the electronic device 100 can recognize the number of rotation events as 1.

Next, the electronic device 100 can determine whether the measured number of rotation events is equal to or greater than a reference value in step 907. According to various embodiments, the electronic device 100 can refer to a pivot table stored in the memory 110. For example, the electronic device 100 can compare the number of rotation events measured for a predetermined time with the pivot table value shown in Table 1.

When the measured number of rotation events is less than the reference value, the electronic device 100 can reduce a zoom-in or zoom-out speed in step 909. According to various embodiments, the electronic device 100 can reduce the zoom-in or zoom-out speed of the barrel to a zoom speed corresponding to Table 1.

When the measured number of rotation events is equal to or greater than the reference value, the electronic device 100 can increase the zoom-in or zoom-out speed in step 911. According to various embodiments, the electronic device 100 can increase the zoom-in or zoom-out speed of the barrel to a zoom speed corresponding to Table 1.

An instruction set for each operation can be stored as one or more modules in the above-described memory 110. In this case, the module stored in the memory 110 can be executed by one or more processors 122.

According to various embodiments, the electronic device 100 can include a plurality of camera modules 106. Also, the camera module 106 can operate in various ways.

According to various embodiments, each of modules can be configured in a software, a firmware, a hardware, or a combination thereof. Also, all or a portion of a module can be configured in one entity and can perform the function of each module. According to various embodiments of this disclosure, respective operations can be executed sequentially, repetitively, or in parallel. Also, some of operations can be omitted or other operations can be added and executed. For example, respective operations can be executed by a corresponding module described by the present disclosure.

Also, methods according to embodiments described in claims and/or the specification of the present disclosure can be implemented in the form of a hardware, a software, or a combination of a hardware and a software.

In case of implementation in the form of a software, a computer readable storage medium for storing one or more programs (software modules) can be provided. One or more programs stored in the computer readable storage medium are configured for execution by one or more processors inside the electronic device. One or more programs can include instructions for enabling the electronic device to execute the methods according to the embodiments described in claims and/or the specification of the present disclosure.

This program (a software module, a software) can be stored in Random Access Memory (RAM), a non-volatile memory including a flash memory, Read Only Memory (ROM), an Electrically Erasable Programmable Read Only Memory (EEPROM), a magnetic disc storage device, a Compact Disc (CD)-ROM, Digital Versatile Discs (DVDs), or other types of optical storage devices, and a magnetic cassette. Alternatively, the program can be stored in a memory configured by a portion or all of these. Also, a plurality of respective element memories can be provided.

Also, the program can be stored in an attachable storage accessible to the electronic device via a communication network such as the Internet, an Intranet, a Local Area Network (LAN), Wide LAN (WLAN), or SAN, or a communication network configured in a combination of these. The storage can access the electronic device via an external port.

Also, a separate storage on a communication network can access a portable electronic device.

Although the disclosure has been shown and described with reference to certain exemplary embodiments thereof, it will be understood by those skilled in the art that various changes in form and details can be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A method in an electronic device, the method comprising:
detecting a rotation event of a zoom ring for a predetermined time;
determining a zoom speed of a barrel in response to the detected rotation event; and
performing a zoom-in function or a zoom-out function with the determined zoom speed.

2. The method of claim 1, wherein detecting the rotation event of the zoom ring for the predetermined time comprises:
measuring the number of rotation events of the zoom ring for the predetermined time.

3. The method of claim 2, wherein the number of rotation events is the number of times by which a plurality of objects to be sensed and installed on the zoom ring are sensed by a sensing means of the electronic device.

4. The method of claim 3, wherein the object to be sensed is a magnet, and a magnetic force of the magnet is sensed by a Hall sensor or a rotation sensor.

5. The method of claim 2, wherein when the object to be sensed is not sensed, an operation of the barrel is stopped.

6. The method of claim 2, wherein when the measured number of rotation events is equal to or greater than a reference value, the zoom speed increases, and when the measured number of rotation events is less than the reference value, the zoom speed decreases.

7. The method of claim 2, further comprising:
comparing the number of rotation events with a value of a pivot table stored in a memory of the electronic device in order to determine the zoom speed.

8. The method of claim 2, further comprising:
when measuring the number of rotation events for the predetermined time, detecting at least one of a rotation speed, a rotation acceleration, or a rotation direction of the zoom ring.

9. The method of claim 8, further comprising:
performing a zoom-in function or a zoon-out function of the barrel depending on the rotation direction of the zoom ring.

10. The method of claim 8, further comprising:
determining the zoom speed depending on the rotation speed of the zoom ring.

11. An electronic device comprising:
a camera module comprising a zoom ring and a barrel; and
a processor coupled to the camera module,
wherein the processor is configured to sense a rotation event of the zoom ring for a predetermined time, to determine a zoom speed of a barrel in response to the sensed rotation event, and to perform a zoom-in function or a zoom-out function with the determined zoom speed.

12. The electronic device of claim 11, wherein the processor is configured to measure the number of rotation events of the zoom ring for a predetermined time.

13. The electronic device of claim 12, further comprising:
a sensing unit configured to sense a plurality of objects to be sensed and installed on the zoom ring in order to measure the number of rotation events.

14. The electronic device of claim 13, wherein the object to be sensed is a magnet, and a magnetic force of the magnet is sensed by a Hall sensor or a rotation sensor.

15. The electronic device of claim 12, wherein when the object to be sensed is not sensed, the processor is configured to stop an operation of the barrel.

16. The electronic device of claim 12, wherein when the measured number of rotation events is equal to or greater than a reference value, the processor is configured to increase the zoom speed, and when the measured number of rotation events is less than the reference value, the processor is configured to reduce the zoom speed.

17. The electronic device of claim 12, wherein the processor is configured to compare the number of rotation events with a pivot table value stored in a memory of the electronic device and to determine the zoom speed.

18. The electronic device of claim 12, wherein when measuring the number of rotation events for a predetermined time, the processor is configured to detect at least one of a rotation speed, a rotation acceleration, or a rotation direction of the zoom ring.

19. The electronic device of claim 18, wherein the processor is configured to perform a zoom-in function or a zoon-out function of the barrel depending on the rotation direction of the zoom ring.

20. The electronic device of claim 18, wherein the processor is configured to determine the zoom speed depending on the rotation speed of the zoom ring.
